(19) United States
(12) Patent Application Publication
(10) Pub. No.: US 2005/0273776 A1
(43) Pub. Date: Dec. 8, 2005

(54) Assembler supporting pseudo registers to resolve return address ambiguity

(75) Inventor: James D. Guilford, Northborough, MA (US)

Correspondence Address: Daly, Crowley & Mofford, LLP;PortfolioIP, P.O. Box 52050, Minneapolis, MN, 55402, US

(73) Assignee: Intel Corporation

(21) Appl. No.: 10/863,300

(22) Filed: Jun. 8, 2004

(51) Int. Cl. G06F 9/45

(52) U.S. Cl. 717/144

(57) ABSTRACT

An assembler, which can form part of a development/debug system, supports pseudo instructions to enable the assembler to resolve return address ambiguities.

### CROSS REFERENCE TO RELATED APPLICATIONS

Not Applicable.

### STATEMENT REGARDING FEDERALLY SPONSORED RESEARCH

Not Applicable.

### BACKGROUND

As is known in the art, assemblers process assembly code that is closely coupled to a target hardware environment. In some conventional assembler code environments, a programmer generates code instructions to manipulate available hardware resources by name. In other known assemblers, virtual hardware resources, such as virtual registers, are used in an assembler program. In general, the assembler maps the virtual resources to physical resources in the target hardware.

When attempting to do code optimization and/or automatic allocation from virtual to physical resources, the assembler needs to understand the flow of the program to determine the return address from a subroutine call, for example. In some cases, the assembler can track the value stored in registers to ascertain the possible return addresses. However, there are some situations that render a determination of return addresses impossible or extremely difficult. For example, the pushing and subsequent popping of a return address on some sort of stack is problematic for the assembler. Another difficulty for the assembler is created when the address undergoes a series of calculations, such as having other data logically ORed into high-order bits and then later removed.

### BRIEF DESCRIPTION OF THE DRAWINGS

The exemplary embodiments will be more fully understood from the following detailed description taken in conjunction with the accompanying drawings, in which:

FIG. 1 is a block diagram of a processor having processing elements that support multiple threads of execution;

FIG. 2 is a block diagram of an exemplary processing element (PE) that runs microcode;

FIG. 3 is a depiction of some local Control and Status Registers (CSRs) of the PE of FIG. 2;

FIG. 4 is a schematic depiction of an exemplary development/debugging system that can be used to develop/debug microcode for the PE shown in FIG. 2;

FIG. 5 is a block diagram illustrating the various components of the development/debugger system of FIG. 4;

FIG. 6 is a textual/pictorial representation of pseudo instructions to resolve return address ambiguity;

FIG. 7 is a further textual/pictorial representation of pseudo instructions to resolve return address ambiguity;

FIG. 8 is a graphical representation of a flow graph;

FIG. 9 is a flow diagram showing an exemplary process to generate a flow graph;

FIG. 9A is a graphical representation of a flow graph;

FIG. 10 is a flow diagram showing further details of a process to generate a flow graph;

FIG. 11 is a schematic representation of an exemplary computer system suited to run an assembler supporting pseudo registers to resolve return address ambiguity; and

FIG. 12 is a diagram of a network forwarding device.

### DETAILED DESCRIPTION

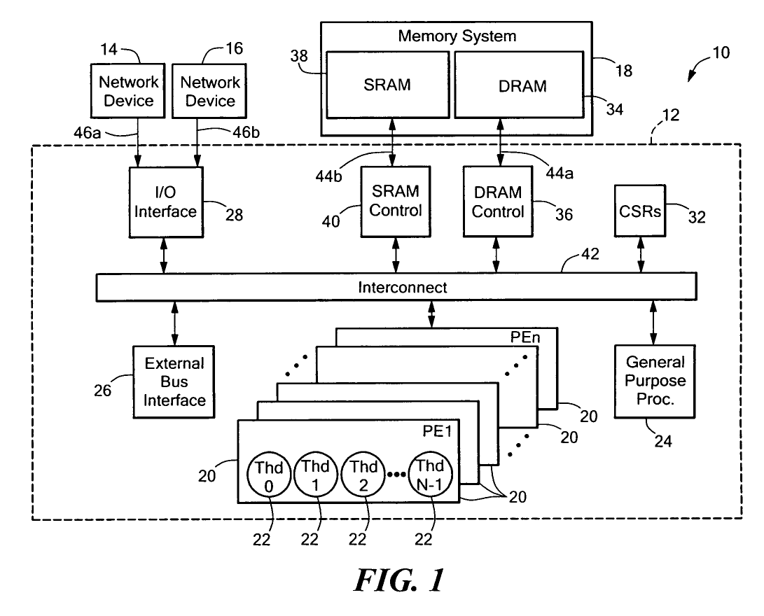

FIG. 1 shows a system 10 including a processor 12 that can contain microcode developed by a programmer using an assembler supporting pseudo instructions and pseudo registers to resolve return address ambiguities in program code. As described more fully below, the pseudo instructions enable the assembler to resolve return addresses for situations such as addresses contained in a register that is pushed onto a stack and subsequently popped off the stack.

The processor 12 is coupled to one or more I/O devices, for example, network devices 14 and 16, as well as a memory system 18. The processor 12 includes multiple processors (“processing engines” or “PEs”) 20, each with multiple hardware controlled execution threads 22. In the example shown, there are “n” processing elements 20, and each of the processing elements 20 is capable of processing multiple threads 22, as will be described more fully below. In the described embodiment, the maximum number “N” of threads supported by the hardware is eight. Each of the processing elements 20 is connected to and can communicate with adjacent processing elements.

In one embodiment, the processor 12 also includes a general-purpose processor 24 that assists in loading microcode control for the processing elements 20 and other resources of the processor 12, and performs other computer type functions such as handling protocols and exceptions. In network processing applications, the processor 24 can also provide support for higher layer network processing tasks that cannot be handled by the processing elements 20.

The processing elements 20 each operate with shared resources including, for example, the memory system 18, an external bus interface 26, an I/O interface 28 and Control and Status Registers (CSRs) 32. The I/O interface 28 is responsible for controlling and interfacing the processor 12 to the I/O devices 14, 16. The memory system 18 includes a Dynamic Random Access Memory (DRAM) 34, which is accessed using a DRAM controller 36 and a Static Random Access Memory (SRAM) 38, which is accessed using an SRAM controller 40. Although not shown, the processor 12 also would include a nonvolatile memory to support boot operations. The DRAM 34 and DRAM controller 36 are typically used for processing large volumes of data, e.g., in network applications, processing of payloads from network packets. In a networking implementation, the SRAM 38 and SRAM controller 40 are used for low latency, fast access tasks, e.g., accessing look-up tables, storing buffer descriptors and free buffer lists, and so forth.

The devices 14, 16 can be any network devices capable of transmitting and/or receiving network traffic data, such as framing/MAC devices, e.g., for connecting to 10/100BaseT Ethernet, Gigabit Ethernet, ATM or other types of networks, or devices for connecting to a switch fabric. For example, in one arrangement, the network device 14 could be an Ethernet MAC device (connected to an Ethernet network, not shown) that transmits data to the processor 12 and device 16 could be a switch fabric device that receives processed data from processor 12 for transmission onto a switch fabric.

In addition, each network device 14, 16 can include a plurality of ports to be serviced by the processor 12. The I/O interface 28 therefore supports one or more types of interfaces, such as an interface for packet and cell transfer between a PHY device and a higher protocol layer (e.g., link layer), or an interface between a traffic manager and a switch fabric for Asynchronous Transfer Mode (ATM), Internet Protocol (IP), Ethernet, and similar data communications applications. The I/O interface 28 may include separate receive and transmit blocks, and each may be separately configurable for a particular interface supported by the processor 12.

Other devices, such as a host computer and/or bus peripherals (not shown), which may be coupled to an external bus controlled by the external bus interface 26 can also serviced by the processor 12.

In general, as a network processor, the processor 12 can interface to various types of communication devices or interfaces that receive/send data. The processor 12 functioning as a network processor could receive units of information from a network device like network device 14 and process those units in a parallel manner. The unit of information could include an entire network packet (e.g., Ethernet packet) or a portion of such a packet, e.g., a cell such as a Common Switch Interface (or “CSIX”) cell or ATM cell, or packet segment. Other units are contemplated as well.

Each of the functional units of the processor 12 is coupled to an internal bus structure or interconnect 42. Memory busses 44a, 44b couple the memory controllers 36 and 40, respectively, to respective memory units DRAM 34 and SRAM 38 of the memory system 18. The I/O Interface 28 is coupled to the devices 14 and 16 via separate I/O bus lines 46a and 46b, respectively.

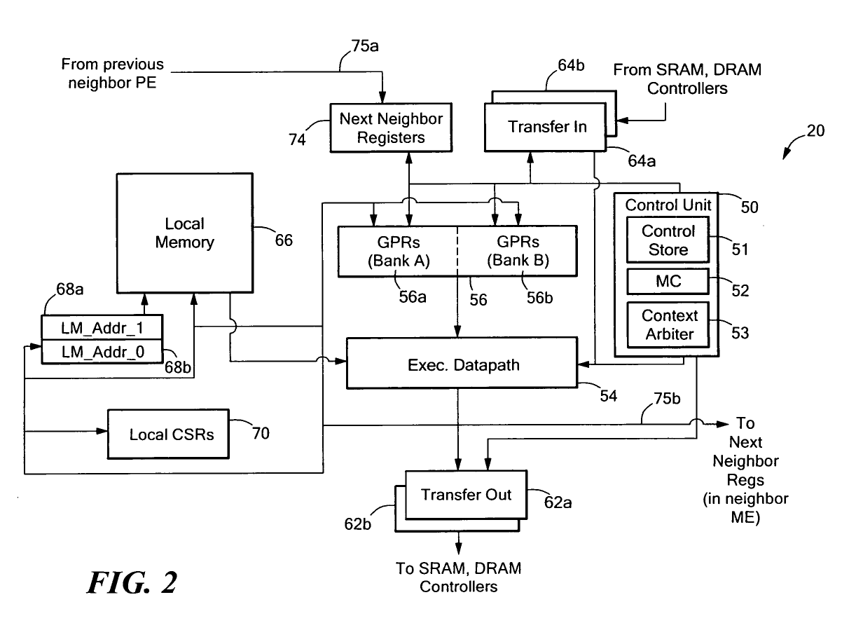

Referring to FIG. 2, an exemplary one of the processing elements 20 is shown. The processing element (PE) 20 includes a control unit 50 that includes a control store 51, control logic (or microcontroller) 52 and a context arbiter/event logic 53. The control store 51 is used to store microcode. The microcode is loadable by the processor 24. The functionality of the PE threads 22 is therefore determined by the microcode loaded via the core processor 24 for a particular user's application into the processing element's control store 51.

The microcontroller 52 includes an instruction decoder and program counter (PC) unit for each of the supported threads. The context arbiter/event logic 53 can receive messages from any of the shared resources, e.g., SRAM 38, DRAM 34, or processor core 24, and so forth. These messages provide information on whether a requested function has been completed.

The PE 20 also includes an execution datapath 54 and a general purpose register (GPR) file unit 56 that is coupled to the control unit 50. The datapath 54 may include a number of different datapath elements, e.g., an ALU, a multiplier and a Content Addressable Memory (CAM).

The registers of the GPR file unit 56 (GPRs) are provided in two separate banks, bank A 56a and bank B 56b. The GPRs are read and written exclusively under program control. The GPRs, when used as a source in an instruction, supply operands to the datapath 54. When used as a destination in an instruction, they are written with the result of the datapath 54. The instruction specifies the register number of the specific GPRs that are selected for a source or destination. Opcode bits in the instruction provided by the control unit 50 select which datapath element is to perform the operation defined by the instruction.

The PE 20 further includes write transfer (transfer out) register file 62 and a read transfer (transfer in) register file 64. The write transfer registers of the write transfer register file 62 store data to be written to a resource external to the processing element. In the illustrated embodiment, the write transfer register file is partitioned into separate register files for SRAM (SRAM write transfer registers 62a) and DRAM (DRAM write transfer registers 62b). The read transfer register file 64 is used for storing return data from a resource external to the processing element 20. Like the write transfer register file, the read transfer register file is divided into separate register files for SRAM and DRAM, register files 64a and 64b, respectively. The transfer register files 62, 64 are connected to the datapath 54, as well as the control store 50. It should be noted that the architecture of the processor 12 supports “reflector” instructions that allow any PE to access the transfer registers of any other PE.

Also included in the PE 20 is a local memory 66. The local memory 66 is addressed by registers 68a (“LM_Addr_{—}1”), 68b (“LM_Addr_{—}0”), which supplies operands to the datapath 54, and receives results from the datapath 54 as a destination.

The PE 20 also includes local control and status registers (CSRs) 70, coupled to the transfer registers, for storing local inter-thread and global event signaling information, as well as other control and status information. Other storage and functions units, for example, a Cyclic Redundancy Check (CRC) unit (not shown), may be included in the processing element as well.

Other register types of the PE 20 include next neighbor (NN) registers 74, coupled to the control store 50 and the execution datapath 54, for storing information received from a previous neighbor PE (“upstream PE”) in pipeline processing over a next neighbor input signal 76a, or from the same PE, as controlled by information in the local CSRs 70. A next neighbor output signal 76b to a next neighbor PE (“downstream PE”) in a processing pipeline can be provided under the control of the local CSRs 70. Thus, a thread on any PE can signal a thread on the next PE via the next neighbor signaling.

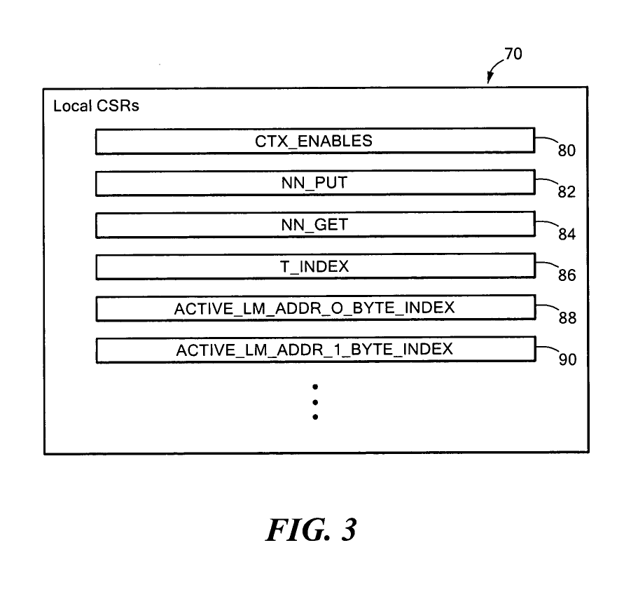

Generally, the local CSRs 70 are used to maintain context state information and inter-thread signaling information. Referring to FIG. 3, registers in the local CSRs 70 may include the following: CTX_ENABLES 80; NN_PUT 82; NN_GET 84; T_INDEX 86; ACTIVE_LM ADDR_{—}0_BYTE_INDEX 88; and ACTIVE_LM ADDR_{—}1_BYTE_INDEX 90. The CTX_ENABLES register 80 specifies, among other information, the number of contexts in use (which determines GPR and transfer register allocation) and which contexts are enabled. It also controls how NN mode, that is, how the NN registers in the PE are written (NN_MODE=‘0’ meaning that the NN registers are written by a previous neighbor PE, NN_MODE=‘1’ meaning the NN registers are written from the current PE to itself). The NN_PUT register 82 contains the “put” pointer used to specify the register number of the NN register that is written using indexing. The NN_GET register 84 contains the “get” pointer used to specify the register number of the NN register that is read when using indexing. The T_INDEX register 86 provides a pointer to the register number of the transfer register (that is, the S_TRANSFER register 62a or D_TRANSFER register 62b) that is accessed via indexed mode, which is specified in the source and destination fields of the instruction. The ACTIVE_LM ADDR_{—}0_BYTE_INDEX 88 and ACTIVE_LM ADDR_{—}1_BYTE_INDEX 90 provide pointers to the number of the location in local memory that is read or written. Reading and writing the ACTIVE_LM_ADDR_x_BYTE_INDEX register reads and writes both the corresponding LM_ADDR_x register and BYTE INDEX registers (also in the local CSRs).

In the illustrated embodiment, the GPR, transfer and NN registers are provided in banks of 128 registers. The hardware allocates an equal portion of the total register set to each PE thread. The 256 GPRs per-PE can be accessed in thread-local (relative) or absolute mode. In relative mode, each thread accesses a unique set of GPRs (e.g., a set of 16 registers in each bank if the PE is configured for 8 threads). In absolute mode, a GPR is accessible by any thread on the PE. The mode that is used is determined at compile (or assembly) time by the programmer. The transfer registers, like the GPRs, can be assessed in relative mode or in absolute-mode. If accessed globally in absolute mode, they are accessed indirectly through an index register, the T_INDEX register. The T_INDEX is loaded with the transfer register number to access.

As discussed earlier, the NN registers can be used in one or two modes, the “neighbor” and “self” modes (configured using the NN_MODE bit in the CTX_ENABLES CSR). The “neighbor” mode makes data written to the NN registers available in the NN registers of a next (adjacent) downstream PE. In the “self” mode, the NN registers are used as extra GPRs. That is, data written into the NN registers is read back by the same PE. The NN_GET and NN_PUT registers allow the code to treat the NN registers as a queue when they are configured in the “neighbor” mode. The NN_GET and NN_PUT CSRs can be used as the consumer and producer indexes or pointers into the array of NN registers.

At any give time, each of the threads (or contexts) of a given PE is in one of four states: inactive; executing; ready and sleep. At most one thread can be in the executing state at a time. A thread on a multi-threaded processor such as PE 20 can issue an instruction and then swap out, allowing another thread within the same PE to run. While one thread is waiting for data, or some operation to complete, another thread is allowed to run and complete useful work. When the instruction is complete, the thread that issued it is signaled, which causes that thread to be put in the ready state when it receives the signal. Context switching occurs only when an executing thread explicitly gives up control. The thread that has transitioned to the sleep state after executing and is waiting for a signal is, for all practical purposes, temporarily disabled (for arbitration) until the signal is received.

While illustrative target hardware is shown and described herein in some detail, it is understood that the exemplary embodiments shown and described herein for an assembler supporting pseudo instructions/registers to provide resolution of return addresses are applicable to a variety of hardware, processors, architectures, devices, development/debuggers systems and the like.

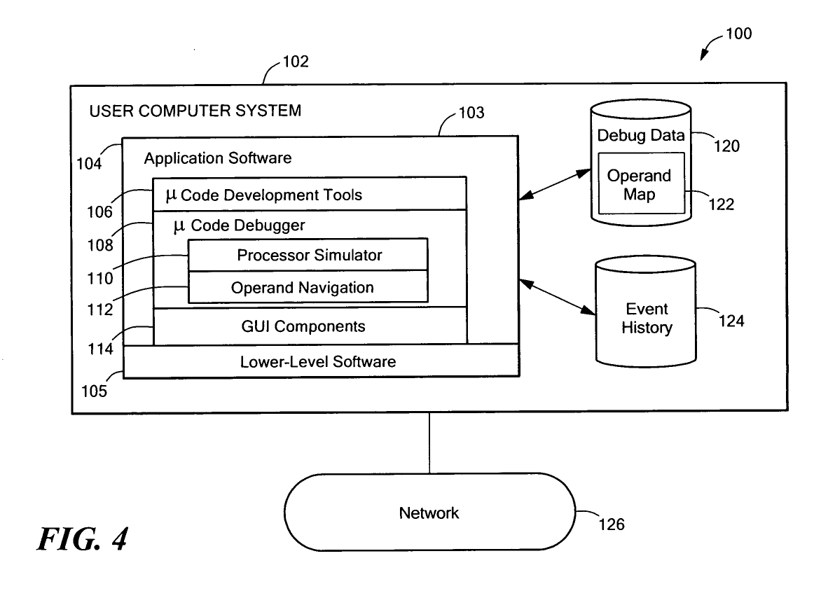

FIG. 4 shows an integrated development/debugger system environment 100 that includes a user computer system 102. The computer system 102 is configured to develop/process/debug microcode that is intended to execute on a processing element. In one embodiment, to be described, the processing element is the PE 20, which may operate in conjunction with other PEs 20, as shown in FIGS. 1-2.

Software 103 includes both upper-level application software 104 and lower-level software (such as an operating system or “OS”) 105. The application software 104 includes microcode development tools 106 (for example, in the example of processor 12, a compiler and/or assembler, and a linker, which takes the compiler or assembler output on a per-PE basis and generates an image file for all specified PEs). The application software 104 further includes a source level microcode debugger 108, which include a processor simulator 110 (to simulate the hardware features of processor 12) and an Operand Navigation mechanism 112. Also include in the application software 104 are GUI components 114, some of which support the Operand Navigation mechanism 112. The Operand Navigation 112 can be used to trace instructions.

Still referring to FIG. 4, the system 102 also includes several databases. The databases include debug data 120, which is “static” (as it is produced by the compiler/linker or assembler/linker at build time) and includes an Operand Map 122, and an event history 124. The event history stores historical information (such as register values at different cycle times) that is generated over time during simulation. The system 102 may be operated in standalone mode or may be coupled to a network 126 (as shown).

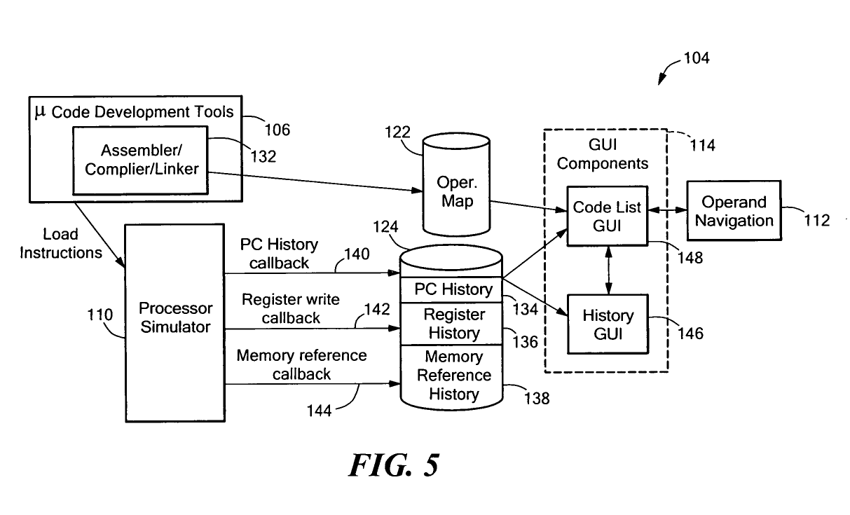

FIG. 5 shows a more detailed view of the various components of the application software 104 for the debugger/simulator system of FIG. 4. They include an assembler and/or compiler, as well as linker 132; the processor simulator 110; the Event History 124; the (Instruction) Operation Map 126; GUI components 114; and the Operand Navigation process 112. The Event History 124 includes a Thread (Context)/PC History 134, a Register History 136 and a Memory Reference History 138. These histories, as well as the Operand Map 122, exist for every PE 20 in the processor 12.

As is known in the art, an assembler processes assembler code, which can be fairly arbitrary. In contrast, a compiler processes a program written in a higher level programming language. Programming languages for compilers typically support well-defined subroutine call/return semantics. That is, when a subroutine calls another subroutine, the compiler knows/specifies where the called-routine will return to without knowing any details of the other subroutine's code. In assembly programming, the programmer is under no such restriction, and thus the assembler needs to determine where the subroutine is going to return by analyzing the subroutine code.

The assembler and/or compiler produce the Operand Map 122 and, along with a linker, provide the microcode instructions to the processor simulator 110 for simulation. During simulation, the processor simulator 110 provides event notifications in the form of callbacks to the Event History 124. The callbacks include a PC History callback 140, a register write callback 142 and a memory reference callback 144. In response to the callbacks, that is, for each time event, the processor simulator can be queried for PE state information updates to be added to the Event History. The PE state information includes register and memory values, as well as PC values. Other information may be included as well.

Collectively, the databases of the Event History 124 and the Operand Map 122 provide enough information for the Operand Navigation 112 to follow register source-destination dependencies backward and forward through the PE microcode.

In exemplary embodiments, an assembler supports pseudo registers to resolve return address ambiguity for the assembler. The assembler can form a part of a debug/development system, such as system 102 of FIG. 4, and can provide instructions (microcode) for processing elements, such as the processing elements 20 of FIGS. 1 and 2. The assembler, which accepts relatively arbitrary assembly code, processes assembly code and attempts to perform code optimizations and/or automatic register allocation. The code contains references to virtual resources, such as registers, that are mapped to physical resources in the target hardware by the assembler.

To perform these tasks, the assembler generates a flow graph of the program. A flow-graph refers to a graph representing the control flow of a program where each node in the flow graph represents a given instruction or microword at a particular address, and each edge connects two instructions that may follow each other in execution order, as described more fully below. Among other things, the generated flow graph is a tool used by the assembler to allocate physical registers to the virtual registers in the program.

One aspect of generating a program flow graph is determining the return address from a subroutine call. A subroutine call in an assembly program, in contrast to higher level languages that are compiled, is under the control of the programmer. It would be possible, for example, for a caller to specify more than one return address, and then to have the subroutine choose which return address to use. Alternatively, the caller could compute one of several possible return addresses before calling the subroutine. In most cases, the assembler can track the value stored in registers and thereby determine the possible return addresses. However, there are circumstances that render return address resolution by the assembler difficult or impossible. For example, pushing and subsequently popping a return address on some sort of stack may make it impossible for the assembler to determine the return address. In addition, certain computations contained in the code may also present challenges to the assembler. For example, a programmer can generate code such that an address undergoes a series of calculations in which other data is logically ORed into high-order bits and then later removed. The higher order bits, which may be ignored for addressing, can be used to store some type of result.

In an exemplary embodiment, the assembler supports a set of “pseudo-registers” that can hold a return address value and a set of pseudo-instructions that reference these pseudo-registers. The pseudo-registers do not reflect actual registers and the pseudo-instructions do not generate actual instructions. Pseudo-operations on the pseudo-registers can include copying an address from a virtual register to a pseudo-register, copying the address back, and/or returning “directly” to the value in a pseudo-register. Exemplary pseudo instructions are set forth below in Table 1

TABLE 1

| PSEUDO INSTRUCTION | DESCRIPTION |
|---|---|
| copy[pseudo-register, register] | Virtually copy from a register to a pseudo-register |
| copy[register, pseudo-register] | Virtually copy from a pseudo-register to a register |
| rtn[register], addr[pseudo-register] | Encode the rtn to the register, but assume the |
| | address is from the pseudo-register |

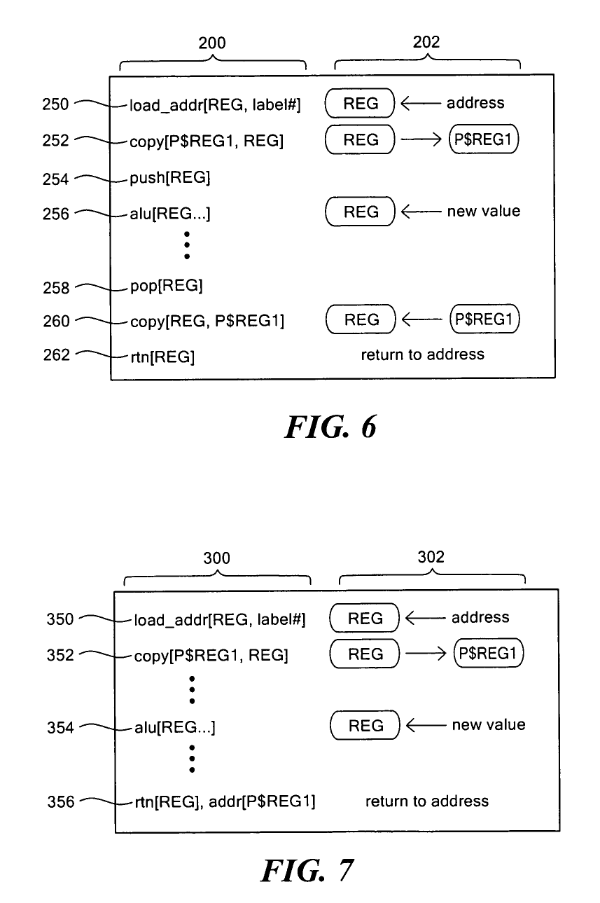

As shown in FIG. 6, pseudo instructions can be provided by the programmer and processed by the assembler to handle code that pushes a return address register onto a stack and later pops the register back off the stack. A code segment 200 of assembly code and an accompanying graphical representation 202 of the instructions are shown.

An address for a label is loaded into a virtual register REG at a first line of assembler code 250. The programmer inserts a pseudo-instruction copy 252 from virtual register REG to pseudo-register P$REG1. In the next line of code 254, the register REG is pushed onto a stack. An arithmetic operation is performed on a value in the register REG in the next line of code 256. At this point, REG no longer holds a valid label address. In a later line of code 258, the register REG is popped off the stack. The programmer knows that this is the value pushed on the stack at 254, but it is beyond the ability of the assembler to determine this. After the pop, the programmer “copies” the value in the pseudo-register P$REG1 into the register REG in the next line of code 260 using a pseudo-instruction. In the next line of code 262, the value (from the pseudo register) in the register REG is returned. As can be seen, by copying the address in the virtual register REG into a pseudo register and later copying this address in the pseudo-register into the register REG, the assembler can determine the return address.

FIG. 7 shows a further illustrative code segment 300 and graphical representation 302 of pseudo instructions that resolve return address ambiguity for the assembler. In a first line 350 of the code segment, an address of a label is loaded into a register REG. The value in the register REG is then copied into a pseudo register P$REG1 in a pseudo instruction 352 inserted by the programmer to resolve return address ambiguity. In a further instruction 354 of the code segment, the programmer puts some data in the high-order return address register using an arithmetic operation, effectively clobbering the value in the virtual register REG from the assembler's point of view. In the last line 358, the value in the pseudo register P$REG1 is provided to the register REG by adding an optional token to the RTN instruction indicating that the actual return address is found in the pseudo register P$REG1.

In general, the virtual register copies and pseudo-registers are used when the assembler computes the flow-graph for the program along with microwords. Once the flow-graph is constructed, pseudo-related elements are ignored and so do not appear in the final output and do not utilize physical resources. The pseudo instructions resolve return address ambiguities by enabling a programmer to indicate the value of the return address register without using actual resources (e.g. instructions, physical registers). In particular, no run-time/machine resources are used, i.e., no instructions are generated, and no physical registers are used.

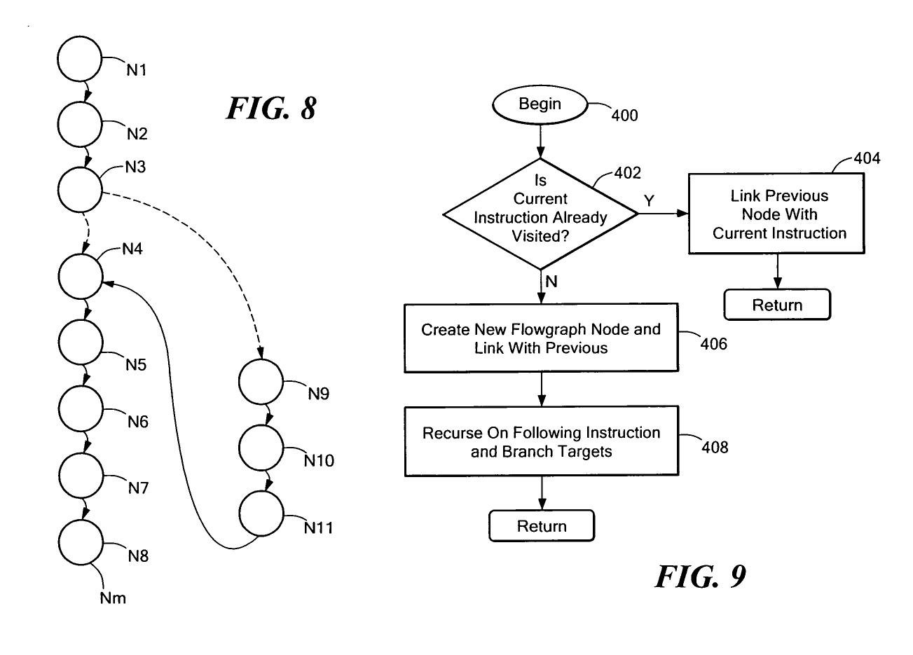

FIG. 8 shows an arbitrary flow graph having a series of nodes N1-Nm each representing program instructions at a given address. Nodes N1-N3 represent consecutive instructions for a code block. At the third node N3, the instruction includes a conditional branch instruction to the fourth node N4 or to the ninth node N9. Nodes N9-N11 can be considered a subroutine. The eleventh node N11 can include a return instruction where a register can provide a return address to the fourth node N4 so that the flow graph jumps to the fourth node N4 and the flow through the fifth node N5 continues.

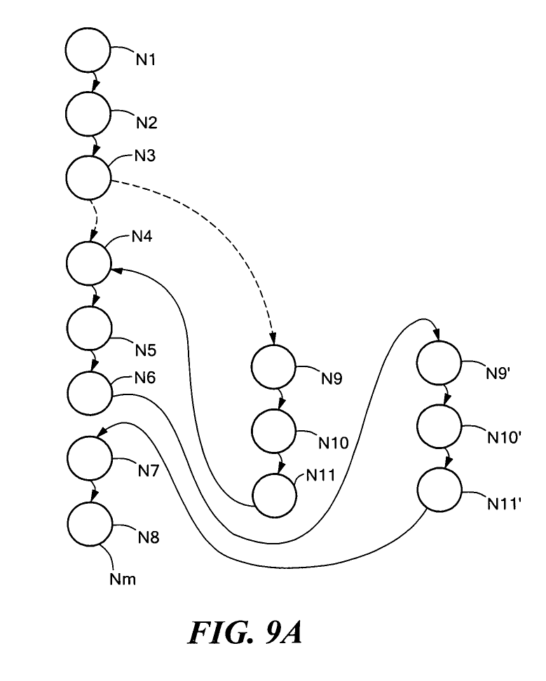

FIG. 9 shows an exemplary implementation of a process to add instructions to a flow graph for an assembler program. The process begins at block 400 and in processing decision block 402, it is determined whether the current instruction has already been visited. If so, the previous node is linked with the current instruction in processing block 404. If not, a new flowgraph node is created for the instruction and linked with the previous node in processing block 406.

In processing block 408, the process recurses on the following instruction and branch targets. The process continues until the flow graph for the program is complete.

In this straightforward process, successor instructions are found and recursively linked into the flowgraph as successors. For non-branching instructions, the single successor would be the following instruction. For an unconditional branch, the single successor is the branch target. For a conditional branch, there are multiple successors, typically the following instruction and the branch target. Whenever a flow merges in with an already visited instruction, that portion of the recursion returns. When the initial recursion returns, the flowgraph is complete.

In the above process, it may not be clear what should occur when a return instruction is reached. This instruction will branch to the instruction whose address is contained in a register. In order to compute the flowgraph in such a case, the assembler needs to know the value stored in the register.

The value in the register can originally come from a load address instruction, which stores the value of a label in a register. Each flowgraph node has associated with it a set of register-address pairs. Whenever a load address instruction is seen, that register and the associated address are added to the current set of register/address. Whenever an assignment is made to a register, any register-address pair for that register is deleted from the set. When a flow reaches an instruction that has already been visited, the recursion only ends if that instruction has a flowgraph node with an identical set. Otherwise, a new flowgraph node is constructed for that instruction with the new register-address pair set, and the recursion continues. For example, as shown in FIG. 9A, which has some commonality with FIG. 8 where like reference numbers indicate like elements, there is a subroutine call between the sixth and seventh nodes N6, N7. In this case, the sixth node N6 branches to nodes N9′ and then nodes N10′ and N11′ before branching back to the seventh node N7. Nodes N9 and N9′ are distinct nodes in the flow graph, although both nodes are associated with the same instruction—in this case the first instruction in the subroutine.

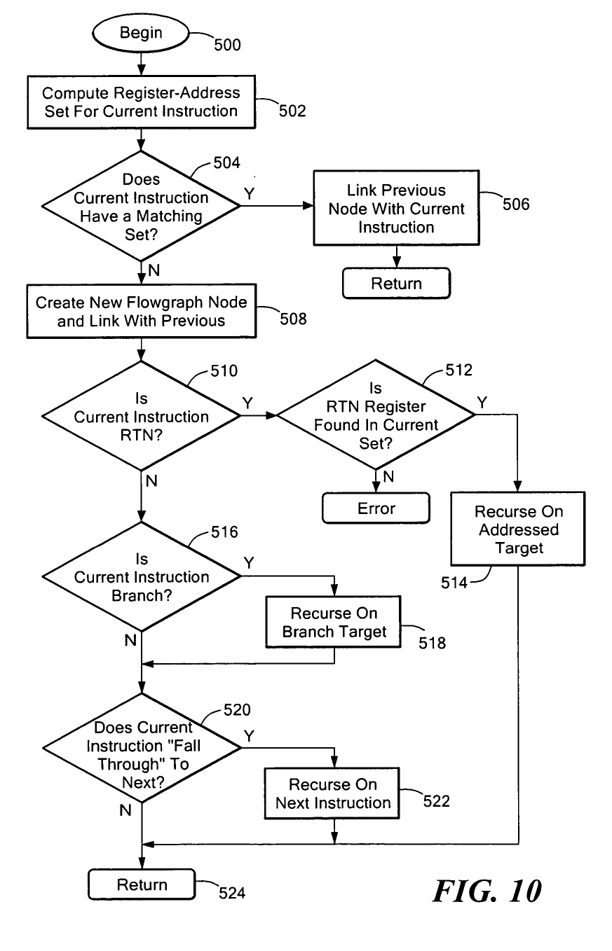

FIG. 10 shows further details of a process to add an instruction to a flow graph for a program. In processing block 500, the process begins and in block 502 the register-address set is computed for the current instruction. An exemplary computation of the new register-address set is provided below.
1. Start with set from previous flowgraph node (if one exists)
2. If current instruction is a label assignment (e.g. LOAD_ADDR)
   2.1. Delete register-address pairs referencing this instruction's label
   2.2. Create new register-address pair.
3. Else if current instruction is a copy and source is different from destination
   3.1. Delete register-address pairs referencing destination register
   3.2. Look up source register in current set, if found create a new register-address pair with the destination register and the address found for the source register
4. Else if register is destination of current instruction
   4.1. Delete register-address pairs referencing destination register
      In processing decision block 504, it is determined whether the current instruction has a flow graph node with a matching register-address set. If so, in processing block 506, the previous flow graph node is linked with the current flow graph node. If not, in processing block 508, a new flowgraph node is created and linked with the previous node. In decision block 510, it is determined whether the current instruction is a return instruction.

If the current instruction is a return instruction, in processing decision block 512 it is determined whether the RTN register is found in the current instruction register-address set. If not, then there is an error and processing is terminated. If so, then in processing block 514, processing recurses on the addressed target.

If the current instruction was not a return instruction as determined in block 510, then in processing block 516 it is determined whether the current instruction is a branch instruction. If so, then processing recurses on the branch target in processing block 518. If not, in processing decision block 520, it is determined whether the current instruction “falls through” to the next instruction. If so, processing recurses on the next instruction in processing block 522. If not, a return instruction for the process is executed in processing block 524.

The pseudo instructions and pseudo registers can resolve return address ambiguities, such as push/pop of an address register and arithmetic instructions involving unused bits of a register, when generating the flow graph.

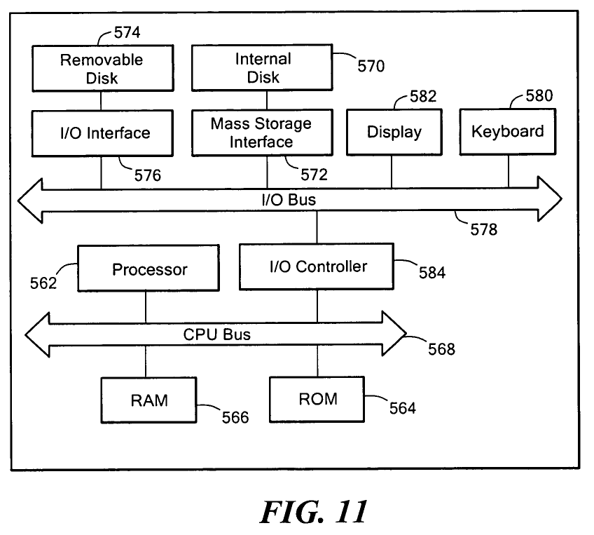

Referring to FIG. 11, an exemplary computer system 560 suitable for use as an assembler and/or a system 102 as a development/debugger system having an assembler supporting pseudo instructions/registers is shown. The assembler may be implemented in a computer program product tangibly embodied in a machine-readable storage device for execution by a computer processor 562; and methods may be performed by the computer processor 562 executing a program to perform functions of the tool by operating on input data and generating output.

Suitable processors include, by way of example, both general and special purpose microprocessors. Generally, the processor 562 will receive instructions and data from a read-only memory (ROM) 564 and/or a random access memory (RAM) 566 through a CPU bus 568. A computer can generally also receive programs and data from a storage medium such as an internal disk 570 operating through a mass storage interface 372 or a removable disk 574 operating through an I/O interface 576. The flow of data over an I/O bus 578 to and from devices 570, 574, (as well as input device 580, and output device 582) and the processor 562 and memory 566, 564 is controlled by an I/O controller 584. User input is obtained through the input device 580, which can be a keyboard, mouse, stylus, microphone, trackball, touch-sensitive screen, or other input device. These elements will be found in a conventional desktop computer as well as other computers suitable for executing computer programs implementing the methods described here, which may be used in conjunction with output device 582, which can be any display device (as shown), or other raster output device capable of producing color or gray scale pixels on paper, film, display screen, or other output medium.

Storage devices suitable for tangibly embodying computer program instructions include all forms of non-volatile memory, including by way of example semiconductor memory devices, such as EPROM, EEPROM, and flash memory devices; magnetic disks such as internal hard disks 570 and removable disks 574; magneto-optical disks; and CD-ROM disks. Any of the foregoing may be supplemented by, or incorporated in, specially-designed ASICs (application-specific integrated circuits).

Typically, processes reside on the internal disk 574. These processes are executed by the processor 562 in response to a user request to the computer system's operating system in the lower-level software 105 after being loaded into memory. Any files or records produced by these processes may be retrieved from a mass storage device such as the internal disk 570 or other local memory, such as RAM 566 or ROM 564.

The system 102 illustrates a system configuration in which the application software 104 is installed on a single stand-alone or networked computer system for local user access. In an alternative configuration, e.g., the software or portions of the software may be installed on a file server to which the system 102 is connected by a network, and the user of the system accesses the software over the network.

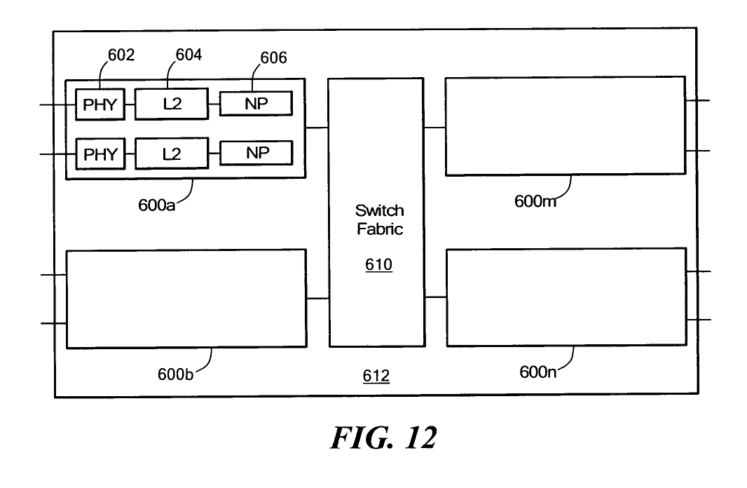

FIG. 12 depicts a network forwarding device that can include a network processor having microcode produced by an assembler supporting pseudo instructions/registers to resolve return address ambiguities. As shown, the device features a collection of line cards 600 (“blades”) interconnected by a switch fabric 610 (e.g., a crossbar or shared memory switch fabric). The switch fabric, for example, may conform to CSIX or other fabric technologies such as HyperTransport, Infiniband, PCI, Packet-Over-SONET, RapidIO, and/or UTOPIA (Universal Test and Operations PHY Interface for ATM).

Individual line cards (e.g., 600a) may include one or more physical layer (PHY) devices 602 (e.g., optic, wire, and wireless PHYs) that handle communication over network connections. The PHYs translate between the physical signals carried by different network mediums and the bits (e.g., “0”-s and “1”-s) used by digital systems. The line cards 600 may also include framer devices (e.g., Ethernet, Synchronous Optic Network (SONET), High-Level Data Link (HDLC) framers or other “layer 2” devices) 604 that can perform operations on frames such as error detection and/or correction. The line cards 600 shown may also include one or more network processors 606 that perform packet processing operations for packets received via the PHY(s) 602 and direct the packets, via the switch fabric 610, to a line card providing an egress interface to forward the packet. Potentially, the network processor(s) 606 may perform “layer 2” duties instead of the framer devices 604.

While FIGS. 1, 2, 3 and 12 describe specific examples of a network processor and a device incorporating network processors, the techniques described herein may be implemented in a variety of circuitry and architectures including network processors and network devices having designs other than those shown. Additionally, the techniques may be used in a wide variety of network devices (e.g., a router, switch, bridge, hub, traffic generator, and so forth).

The term circuitry as used herein includes hardwired circuitry, digital circuitry, analog circuitry, programmable circuitry, and so forth. The programmable circuitry may operate on computer programs.

One skilled in the art will appreciate further features and advantages of the above-described embodiments, which is not to be limited by what has been particularly shown and described, except as indicated by the appended claims.

1. A method of processing an assembler program, comprising;
processing an assembly code program referencing virtual registers and having one or more pseudo instruction referencing a pseudo register;
generating a flow graph for the program; and
processing the pseudo instruction to resolve return address ambiguities.

2. The method according to claim 1, wherein the pseudo instructions include one or more of copying a virtual register value to the pseudo register, copying a value from a pseudo register to a virtual register, and returning a value from the pseudo register.

3. The method according to claim 1, further including processing a first one of the pseudo instructions to resolve a return address ambiguity related to a push/pop of an address register.

4. The method according to claim 1, further including processing a first one of the pseudo instructions to resolve an ambiguity related to use of bits of a register address that leave a branch address intact.

5. The method according to claim 1, further including generating the flow graph to include a register-address set for program instructions.

6. The method according to claim 1, further including allocating the virtual registers to physical registers in target hardware.

7. The method according to claim 1, further including generating microcode for a network processor having a plurality of processing elements.

8. An article comprising:
a storage medium having stored thereon instructions that when executed by a machine result in the following:
processing an assembly code program containing pseudo instructions and references to virtual registers;
generating a flow graph for the program; and
processing the pseudo instructions to resolve return address ambiguities.

9. The article according to claim 8, wherein the pseudo instructions include one or more of copying a virtual register value to a pseudo register, copying a value from a pseudo register to a virtual register, and returning a value from a pseudo register.

10. The article according to claim 8, further including stored instructions to process a first one of the pseudo instructions to resolve a return address ambiguity related to a push/pop of an address register.

11. The article according to claim 8, further including stored instruction to process a first one of the pseudo instructions to resolve an ambiguity related to use of higher order bits of a register address.

12. The article according to claim 8, further including stored instructions to generate the flow graph to include a register-address set for program instructions.

13. A development/debugger system, comprising:
an assembler to generate microcode that is executable in a processing element by
processing an assembly code program containing pseudo instructions and references to virtual registers;
generating a flow graph for the program; and
processing the pseudo instructions to resolve return address ambiguities.

14. The system according to claim 13, wherein the pseudo instructions include one or more of copying a virtual register value to a pseudo register, copying a value from a pseudo register to a virtual register, and returning a value from a pseudo register.

15. The system according to claim 13, further including processing a first one of the pseudo instructions to resolve a return address ambiguity related to a push/pop of an address register.

16. The system according to claim 13, further including processing a first one of the pseudo instructions to resolve an ambiguity related to use of higher order bits of a register address.

17. The system according to claim 13, further including generating the flow graph to include a register-address set for program instructions.

18. A network forwarding device, comprising:
at least one line card to forward data to ports of a switching fabric;
the at least one line card including a network processor having multi-threaded microengines configured to execute microcode, wherein the microcode comprises a microcode developed using an assembler that
processed an assembly code program containing pseudo instructions and references to virtual registers;
generated a flow graph for the program; and
processed the pseudo instructions to resolve return address ambiguities.

19. The device according to claim 18, wherein the pseudo instructions include one or more of copying a virtual register value to a pseudo register, copying a value from a pseudo register to a virtual register, and returning a value from a pseudo register.

20. The device according to claim 18, wherein the assembler processed a first one of the pseudo instructions to resolve a return address ambiguity related to a push/pop of an address register.

21. The device according to claim 18, wherein the assembler processed a first one of the pseudo instructions to resolve an ambiguity related to use of higher order bits of a register address.

22. The device according to claim 18, wherein the assembler generated the flow graph to include a register-address set for program instructions.
